(19) United States
(12) Patent Application Publication
(10) Pub. No.: US 2024/0204964 A1
(43) Pub. Date: Jun. 20, 2024

(54) METHOD AND SYSTEM TO SEND BURST OF UPLINK MESSAGES USING ACARS OVER INTERNET PROTOCOL CHANNELS

(71) Applicant: Honeywell International Inc., Charlotte, NC (US)

(72) Inventors: Thomas D. Judd, Phoenix, AZ (US); Sathish Pakki, Phoenix, AZ (US)

(73) Assignee: Honeywell International Inc., Charlotte, NC (US)

(21) Appl. No.: 18/163,763

(22) Filed: Feb. 2, 2023

(30) Foreign Application Priority Data
Dec. 14, 2022 (IN) 202211072273

(51) Int. Cl. H04L 5/00; H04W 72/21; H04W 76/18

(52) U.S. Cl. CPC H04L 5/0055; H04W 72/21; H04W 76/18

(57) ABSTRACT

A method comprises transmitting uplink messages from an AoIP ground datalink service provider to an AoIP gateway server, when an AoIP communication channel is available; determining whether the uplink messages have been received by the gateway server; storing the uplink messages in the gateway server; and notifying the datalink service provider when each uplink message is received by the gateway server. The method determines whether there are any uplink messages to be sent from the gateway server to a communications management system onboard an aircraft; sends any uplink messages, one at a time, from the gateway server to the communications management system; and transmits an acknowledgement from the communications management system to the gateway server. Each uplink message is sent from the communications management system to an onboard ACARS end system. Subsequent to each acknowledgement, a next uplink message is sent from the gateway server to the communications management system.

### CROSS-REFERENCE TO RELATED APPLICATION

This application claims priority to Indian Provisional Patent Application No. 202211072273 filed on Dec. 14, 2022, the contents of which are incorporated herein by reference in their entirety.

### BACKGROUND

In existing datalink communication systems, when a stable aircraft communications addressing and reporting system (ACARS) over Internet Protocol (IP) link is available, all uplink messages are sent to an aircraft sequentially, one at a time, after an acknowledgement is received from the aircraft. This procedure takes time and does not utilize all of the available communication bandwidth.

For example, airline applications such as weather, maintenance, and operations send multiple uplink messages to a ground datalink service provider to be forwarded to an aircraft. However, the ground datalink service provider only transmits the uplink messages one at a time to an aircraft data gateway (ADG). The ADG forwards the uplink message to a communication management function or communication management unit (CMF/CMU) in the aircraft. The CMU/CMF sends an acknowledgment to the ground datalink service provider that the uplink message is received. When the ground datalink service provider receives the acknowledgment, the next uplink message to the aircraft is initiated.

### SUMMARY

A method comprises transmitting one or more uplink messages from an ACARS over Internet Protocol (AoIP) ground datalink service provider to an AoIP gateway server, when an AoIP communication channel is available; determining whether the one or more uplink messages have been received by the AoIP gateway server; storing the one or more uplink messages in the AoIP gateway server when received; and notifying the AoIP ground datalink service provider when each uplink message is received by the AoIP gateway server. The method further comprises determining whether there are any pending stored uplink messages to be sent from the AoIP gateway server to a communications management system onboard an aircraft; sending the pending stored uplink messages, one at a time, from the AoIP gateway server to the communications management system; and transmitting a respective acknowledgement from the communications management system to the AoIP gateway server, when a corresponding uplink message has been received by the communications management system. Each uplink message is sent from the communications management system to one or more ACARS end systems onboard the aircraft. Subsequent to each respective acknowledgement being received by the AoIP gateway server, the corresponding uplink message is discarded at the AoIP gateway server, and a next one of the uplink messages is sent from the AoIP gateway server to the communications management system.

### BRIEF DESCRIPTION OF THE DRAWINGS

Features of the present invention will become apparent to those skilled in the art from the following description with reference to the drawings. Understanding that the drawings depict only typical embodiments and are not therefore to be considered limiting in scope, the invention will be described with additional specificity and detail through the use of the accompanying drawings, in which:

FIG. 1 is a flow diagram of a method for sending a burst of uplink messages using ACARS over Internet Protocol (AoIP) communication channels, according to an exemplary implementation;

FIG. 2 is a functional block diagram of a system for sending a burst of uplink messages using AoIP communication channels, according to an exemplary embodiment; and

FIG. 3 is a flow diagram of a method for sending a burst of uplink messages using AoIP communication channels, according to another exemplary implementation.

### DETAILED DESCRIPTION

In the following detailed description, embodiments are described in sufficient detail to enable those skilled in the art to practice the invention. It is to be understood that other embodiments may be utilized without departing from the scope of the invention. The following detailed description is, therefore, not to be taken in a limiting sense.

A method and system for sending a burst of uplink messages using ACARS over Internet Protocol (AoIP) channels are described herein. The present approach enhances a communication management unit (CMU) or communication management function (CMF), in aircraft datalink communication systems.

In the present approach, an AoIP ground datalink service provider (DSP) can receive multiple uplink message requests from ground applications such as maintenance, weather, and airline operations. The ground DSP transmits these uplink messages to an AOIP gateway server, such as an Aircraft Data Gateway (ADG) or Integrated Network Server Unit (INSU), when an AoIP communication channel is available. The ground DSP and the ADG/INSU check that the AoIP based data transfer is complete, but not the Aeronautical Radio Inc. (ARINC) 618 layer acknowledgment. The ADG/INSU acts as an onboard service provider to relay ARINC 618 (A618) messages one by one to a CMU/CMF. The CMU/CMF acknowledgements are considered as data transfer complete in the ADG/INSU. Any error messages of the CMU/CMF are sent to ground as a new downlink message, and the corresponding message sequence number at the ground DSP can identify if a given uplink message has failed to transfer to an ACARS end system, or a given uplink message decoding has failed.

For example, suppose the ground DSP has five (5) uplink messages to be sent to an aircraft. The ground DSP sends all five uplink messages to the ADG/INSU. The ADG/INSU saves the five uplink messages, and an IP file transfer informs the ground DSP that all of the uplink messages are transferred to the ADG/INSU. The ADG/INSU then transmits a first uplink message of the saved uplink messages to the CMU/CMF, which upon receipt, sends a first message acknowledgement back to the ADG/INSU. Upon reception of the first message acknowledgement, the ADG/INSU discards the first saved uplink message. The ADG/INSU then transmits the next (second) uplink message to the CMU/CMF, which upon receipt, sends a second message acknowledgement back to the ADG/INSU. Upon reception of the second message acknowledgement, the ADG/INSU discards the second saved uplink message. A corresponding process is followed for transmitting the additional saved uplink messages to the CMU/CMF.

If any uplink message fails to transfer to the CMU/CMF in a maximum acknowledgement time, then the ADG/INSU initiates a data failure indication to the ground DSP. If an uplink message is not processed/delivered by the CMU/CMF, then the CMU/CMF sends a failure indication to the ADG/INSU, which further transfers this information to the ground DSP. These failure messages are uniquely identified by the message sequence number.

The present approach has the benefit of providing improved usage of the AoIP channels bandwidth. Several messages via a high bandwidth link can be uplinked at one time, then delivered in order via an A618/radio interface as an end system becomes available. If the AoIP link is available but about to transition to a region where the AoIP link is not going to be available, the present method allows for transmitting a bulk set of messages up to the aircraft prior to that transition. In addition, the present method provides for faster uplink message deliveries, and improved AoIP datalink capabilities can be provided to Airlines.

Further details regarding the present approach are described as follows and with reference to the drawings.

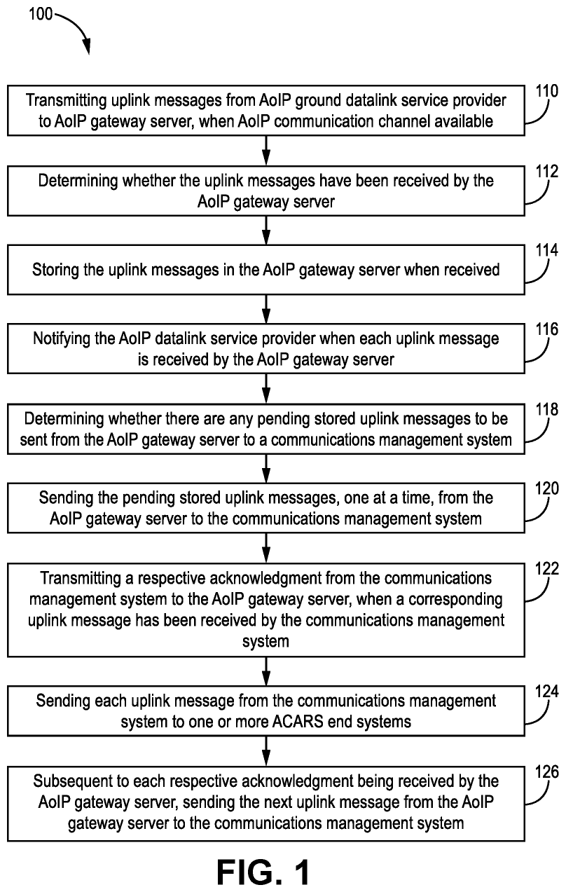

FIG. 1 is a flow diagram of a method 100 for sending a burst of uplink messages using AoIP communication channels, according to an exemplary implementation. The method 100 comprises transmitting one or more uplink messages from an AoIP ground datalink service provider to an AoIP gateway server, when an AoIP communication channel is available (block 110). The method 100 determines whether the one or more uplink messages have been received by the AoIP gateway server (block 112), and stores the one or more uplink messages in the AoIP gateway server when received (block 114). The method 100 notifies the AoIP datalink service provider when each uplink message is received by the AoIP gateway server (block 116).

The method 100 determines whether there are any pending stored uplink messages to be sent from the AoIP gateway server to a communications management system (block 118), such as a CMU or CMF onboard an aircraft. The method 100 sends the pending stored uplink messages, one at a time, from the AoIP gateway server to the communications management system (block 120), such as expected by the CMU/CMF. The method 100 transmits a respective acknowledgement from the communications management system to the AoIP gateway server, when a corresponding uplink message has been received by the communications management system (block 122). Subsequent to each respective acknowledgement being received by the AoIP gateway server, the corresponding uplink message is discarded at the AoIP gateway server. The method 100 sends each uplink message from the communications management system to one or more ACARS end systems onboard the aircraft (block 124). Subsequent to each respective acknowledgement being received by the AoIP gateway server, the next uplink message is sent from the AoIP gateway server to the communications management system (block 126).

In some embodiments, the AoIP gateway server is operative to receive uplink messages in a standard format, such as ARINC 620, and convert the uplink messages to ARINC 618 messages that are sent, one at a time, to the communications management system. In other embodiments, the AoIP gateway server is operative to receive uplink messages in a non-standard format, or in an ARINC 618-like format.

If any of the uplink messages fail to be transferred to the communications management system within an acknowledgement time threshold, then the AoIP gateway server sends a failure indication to the AoIP ground datalink service provider. If any of the uplink messages fail to be transferred to the one or more ACARS end systems within an acknowledgement time threshold, then the communications management system sends a failure indication to the AoIP gateway server, which in turn transfers the failure indication to the AoIP ground datalink service provider.

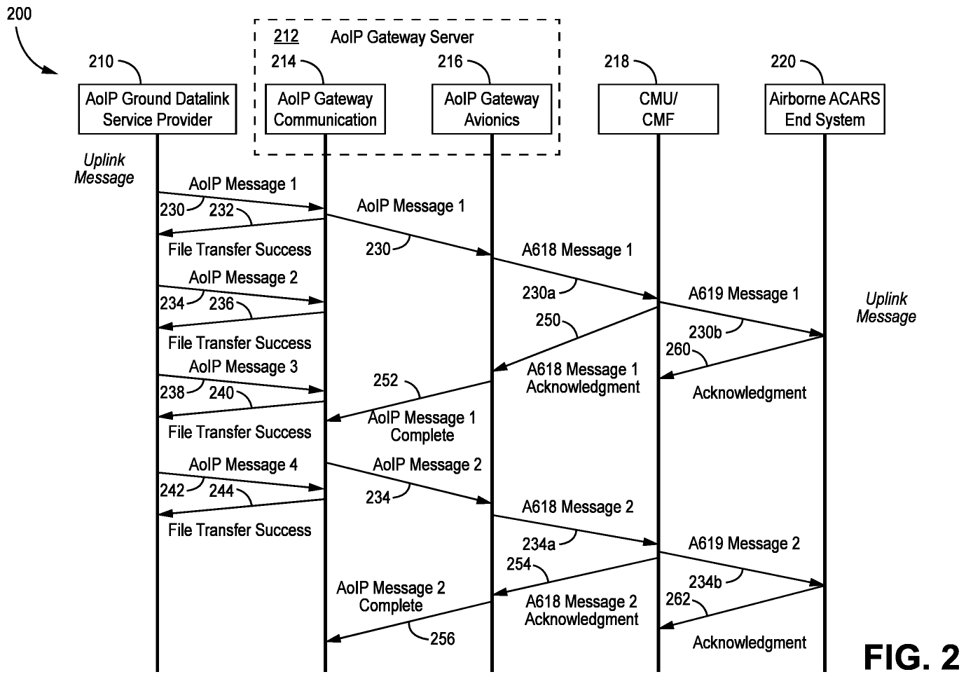

FIG. 2 is a functional diagram of a system 200 for sending a burst of uplink messages using AoIP communication channels, according to an exemplary embodiment. The system 200 comprises an AoIP ground datalink service provider 210, an AoIP gateway server 212 including an AOIP gateway communication portion 214 and an AOIP gateway avionics portion 216, a CMU/CMF 218, and an airborne ACARS end system 220.

The AoIP ground datalink service provider 210 and AoIP gateway server 212 can be cloud-based systems. The AoIP gateway server 212 acts as a connectivity bridge for data flows into and out of an aircraft. Examples of airborne ACARS end system 220 include an aircraft condition monitoring system (ACMS), a digital flight data acquisition management unit (DFDAMU), a central maintenance computer (CMC), an electronic flight bag (EFB), a cabin terminal, a flight management system (FMS), a CMU/CMF application, combinations thereof, and the like.

During operation of system 200, one or more uplink AoIP messages are transmitted from AoIP ground datalink service provider 210 to AOIP gateway communication portion 214 of AoIP gateway server 212. The AOIP gateway communication portion 214 stores each uplink AoIP message when received. The AOIP gateway communication portion 214 then sends a file transfer success message back to AoIP ground datalink service provider 210 for each uplink AoIP message when received.

For example, a first uplink AoIP message 230 is transmitted from AoIP ground datalink service provider 210 to AOIP gateway communication portion 214, which stores the first uplink AoIP message 230 when received. The AOIP gateway communication portion 214 then sends a first file transfer success message 232 back to AoIP ground datalink service provider 210. In addition, a second uplink AoIP message 234 can be transmitted from AoIP ground datalink service provider 210 to AOIP gateway communication portion 214, which stores the second uplink AoIP message 234 when received. The AOIP gateway communication portion 214 then sends a second file transfer success message 236 back to AoIP ground datalink service provider 210. Additionally, a third uplink AoIP message 238 can be transmitted from AoIP ground datalink service provider 210 to AOIP gateway communication portion 214, which stores the third uplink AoIP message 238 when received. The AOIP gateway communication portion 214 then sends a third file transfer success message 240 back to AoIP ground datalink service provider 210. A fourth uplink AoIP message 242 can also be transmitted from AoIP ground datalink service provider 210 to AOIP gateway communication portion 214, 40 which stores the fourth uplink AoIP message 242 when received. The AOIP gateway communication portion 214 then sends a fourth file transfer success message 244 back to AoIP ground datalink service provider 210.

The system 200 sends the stored uplink AoIP messages, one at a time, from the AoIP gateway server 212 to the CMU/CMF 218. For example, the first uplink AoIP message 230 is sent from AOIP gateway communication portion 214 to AOIP gateway avionics portion 216, which transmits the first uplink AoIP message 230 as a first A618 message 230a to CMU/CMF 218. When the first A618 message 230a is received, CMU/CMF 218 sends a first A618 message acknowledgement 250 to AOIP gateway avionics portion 216, which in turn sends an acknowledgement 252 that the first uplink AoIP message is complete to AOIP gateway communication portion 214. The second uplink AoIP message 234 is then sent from AOIP gateway communication portion 214 to AOIP gateway avionics portion 216, which transmits the second uplink AoIP message 234 as a second A618 message 234a to CMU/CMF 218. When the second A618 message 234a is received, CMU/CMF 218 sends a second A618 message acknowledgement 254 to AOIP gateway avionics portion 216, which in turn sends an acknowledgement 256 that the second uplink AoIP message is complete to AOIP gateway communication portion 214. A corresponding protocol is followed for sending the additional stored uplink AoIP messages to CMU/CMF 218.

The system 200 then sends each uplink message from CMU/CMF 218 to ACARS end system 220. For example, the first A618 message 230a is sent as an A619 message 230b to ACARS end system 220, which sends a message acknowledgement 260 to CMU/CMF 218 when the A619 message 230b is received. The second A618 message 234a is then sent as a second A619 message 234b to ACARS end system 220, which sends a message acknowledgement 262 to CMU/CMF 218 when the second A619 message 234b is received. A corresponding protocol is followed for sending the additional uplink messages from CMU/CMF 218 to ACARS end system 220.

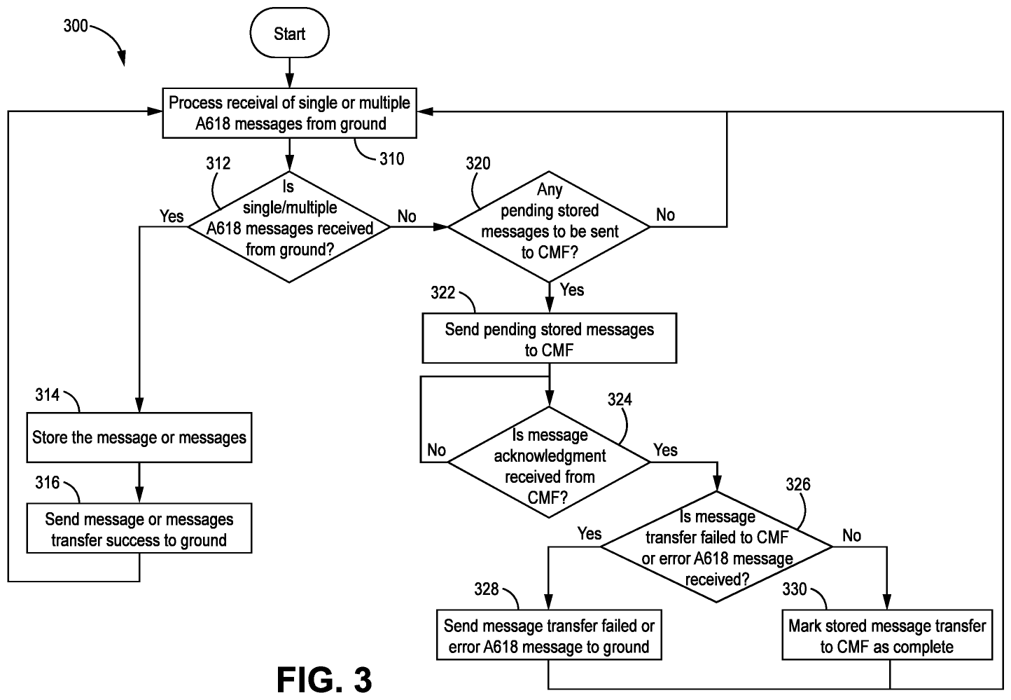

FIG. 3 is a flow diagram of a method 300 for sending a burst of uplink messages using AoIP communication channels, according to another exemplary implementation. At the start, method 300 is operative to monitor and process the receival of single or multiple uplink A618 messages from the ground (block 310), such as from an AoIP ground datalink service provider. The method 300 determines if single or multiple A618 messages are received from the ground (block 312). If yes, method 300 stores the single or multiple uplink messages (block 314), such as in an AoIP gateway server. The method 300 then sends a message or messages of transfer success to the ground (block 316), such as by notifying the AoIP datalink service provider that the single or multiple uplink messages are received by the AoIP gateway server. The method 300 then returns to block 310 to continue monitoring and processing the receival of uplink messages from the ground.

Returning to block 312, if method 300 determines that single or multiple A618 messages are not received from the ground, then method 300 determines if there are any pending stored messages to be sent to a CMF (block 320). If not, method 300 returns to block 310 to continue monitoring and processing the receival of uplink messages from the ground. Returning to block 320, if there are pending stored messages to be sent, method 300 sends the stored messages are sent to the CMF (block 322). The method 300 then determines if there is a message acknowledgment received from the CMF (block 324). If not, method 300 continues to monitor whether there is a message acknowledgment received from the CMF at block 324. If a message acknowledgment is received from the CMF, method 300 then determines if a message transfer failed to CMF or A618 error message is received (block 326). If yes, method 300 sends the message transfer failed to CMF or A618 error message to the ground (block 328). The method 300 then returns to block 310 to continue monitoring and processing the receival of messages from the ground. Returning to block 326, if a message transfer failed to CMF or A618 error message is not received, method 300 marks the stored message transfer to CMF as complete (block 330). The method 300 then returns to block 310 to continue monitoring and processing the receival of messages from the ground.

The processing units and/or other computational devices used in systems and methods described herein may be implemented using software, firmware, hardware, or appropriate combinations thereof. The processing unit and/or other computational devices may be supplemented by, or incorporated in, specially designed application-specific integrated circuits (ASICs) or field programmable gate arrays (FPGAs). In some implementations, the processing unit and/or other computational devices may communicate through an additional transceiver with other computing devices outside of the system, such as those associated with a management system or computing devices associated with other subsystems controlled by the management system. The processing unit and/or other computational devices can also include or function with software programs, firmware, or other computer readable instructions for carrying out various process tasks, calculations, and control functions used in the methods and systems described herein.

The methods described herein may be implemented by computer executable instructions, such as program modules or components, which are executed by at least one processor or processing unit. Generally, program modules include routines, programs, objects, data components, data structures, algorithms, and the like, which perform particular tasks or implement particular abstract data types.

Instructions for carrying out the various process tasks, calculations, and generation of other data used in the operation of the methods described herein can be implemented in software, firmware, or other computer readable instructions. These instructions are typically stored on appropriate computer program products that include computer readable media used for storage of computer readable instructions or data structures. Such a computer readable medium may be available media that can be accessed by a general purpose or special purpose computer or processor, or any programmable logic device.

Suitable computer readable storage media may include, for example, non-volatile memory devices including semi-conductor memory devices such as Random Access Memory (RAM), Read Only Memory (ROM), Electrically Erasable Programmable ROM (EEPROM), or flash memory devices; magnetic disks such as internal hard disks or removable disks; optical storage devices such as compact discs (CDs), digital versatile discs (DVDs), Blu-ray discs; or any other media that can be used to carry or store desired program code in the form of computer executable instructions or data structures.

### Example Embodiments

Example 1 includes a method comprising: transmitting one or more uplink messages from an ACARS over Internet Protocol (AoIP) ground datalink service provider to an AoIP gateway server, when an AoIP communication channel is available; determining whether the one or more uplink messages have been received by the AoIP gateway server; storing the one or more uplink messages in the AoIP gateway server when received; notifying the AoIP ground datalink service provider when each uplink message is received by the AoIP gateway server; determining whether there are any pending stored uplink messages to be sent from the AoIP gateway server to a communications management system onboard an aircraft; sending the pending stored uplink messages, one at a time, from the AoIP gateway server to the communications management system; transmitting a respective acknowledgement from the communications management system to the AoIP gateway server, when a corresponding uplink message has been received by the communications management system, wherein subsequent to each respective acknowledgement being received by the AoIP gateway server, the corresponding uplink message is discarded at the AoIP gateway server; and sending each uplink message from the communications management system to one or more ACARS end systems onboard the aircraft; wherein subsequent to each respective acknowledgement being received by the AoIP gateway server, a next one of the uplink messages is sent from the AoIP gateway server to the communications management system.

Example 2 includes the method of Example 1, wherein if any of the uplink messages fail to be transferred to the communications management system within an acknowledgement time threshold, then the AoIP gateway server sends a failure indication to the AoIP ground datalink service provider.

Example 3 includes the method of any of Examples 1-2, wherein if any of the uplink messages fail to be transferred to the one or more ACARS end systems within an acknowledgement time threshold, then the communications management system sends a failure indication to the AoIP gateway server, which in turn transfers the failure indication to the AoIP ground datalink service provider.

Example 4 includes the method of any of Examples 1-3, wherein the AoIP gateway server includes an aircraft data gateway (ADG), or an integrated network server unit (INSU).

Example 5 includes the method of any of Examples 1-4, wherein the AoIP gateway server includes an AOIP gateway communication portion, and an AOIP gateway avionics portion.

Example 6 includes the method of any of Examples 1-5, wherein the communications management system comprises a communication management unit (CMU), or a communication management function (CMF).

Example 7 includes the method of any of Examples 1-6, wherein the one or more ACARS end systems comprise an aircraft condition monitoring system (ACMS), a digital flight data acquisition management unit (DFDAMU), a central maintenance computer (CMC), an electronic flight bag (EFB), a cabin terminal, a flight management system (FMS), a CMU/CMF application, or combinations thereof.

Example 8 includes the method of any of Examples 1-7, wherein the AoIP gateway server receives uplink messages, and converts the uplink messages to ARINC 618 messages that are sent, one at a time, to the communications management system.

Example 9 includes the method of any of Examples 1-7, wherein the pending stored uplink messages are sent, one at a time, as ARINC 618 messages from the AoIP gateway server to the communications management system.

Example 10 includes the method of any of Examples 8-9, wherein each received ARINC 618 message is sent as a corresponding ARINC 619 message, from the communications management system to the one or more ACARS end systems.

Example 11 includes a system comprising: an ACARS over Internet Protocol (AoIP) ground datalink service provider operative to transmit one or more uplink messages; an AoIP gateway server in operative communication with the AoIP ground datalink service provider, the AoIP gateway server operative to receive and store the one or more uplink messages transmitted by the AoIP ground datalink service provider; wherein the AoIP gateway server is operative to send a transfer success message back to the AoIP ground datalink service provider for each uplink message received by the AoIP gateway server; a communications management system onboard an aircraft and in operative communication with the AoIP gateway server; and one or more ACARS end systems onboard the aircraft and in operative communication with the communications management system; wherein the AoIP gateway server is operative to send the stored one or more uplink messages, one at a time, to the communications management system; wherein when each uplink message is received by the communications management system from the AoIP gateway server, the communications management system sends a message acknowledgement to the AoIP gateway server; wherein the communications management system is operative to send each received uplink message to the one or more ACARS end systems.

Example 12 includes the system of Example 11, wherein if any of the uplink messages fail to be transferred to the communications management system within an acknowledgement time threshold, then the AoIP gateway server sends a failure indication to the AoIP ground datalink service provider.

Example 13 includes the system of any of Examples 11-12, wherein if any of the uplink messages fail to be transferred to the one or more ACARS end systems within an acknowledgement time threshold, then the communications management system sends a failure indication to the AoIP gateway server, which in turn transfers the failure indication to the AoIP ground datalink service provider.

Example 14 includes the system of any of Examples 11-13, wherein the AoIP gateway server includes an aircraft data gateway (ADG), or an integrated network server unit (INSU).

Example 15 includes the system of any of Examples 11-14, wherein the AoIP gateway server includes an AOIP gateway communication portion, and an AOIP gateway avionics portion.

Example 16 includes the system of any of Examples 11-15, wherein the communications management system comprises a communication management unit (CMU), or a communication management function (CMF).

Example 17 includes the system of any of Examples 11-16, wherein the one or more ACARS end systems comprise an aircraft condition monitoring system (ACMS), a digital flight data acquisition management unit (DFDAMU), a central maintenance computer (CMC), an electronic flight bag (EFB), a cabin terminal, a flight management system (FMS), a CMU/CMF application, or combinations thereof.

Example 18 includes the system of any of Examples 11-17, wherein the AoIP gateway server is operative to receive uplink messages, and convert the uplink messages to ARINC 618 messages that are sent, one at a time, to the communications management system.

Example 19 includes the system of any of Examples 11-17, wherein the AoIP gateway server is operative to send the stored one or more uplink messages, one at a time, as ARINC 618 messages to the communications management system.

Example 20 includes the system of any of Examples 18-19, wherein the communications management system is operative to send each received ARINC 618 message, as a corresponding ARINC 619 message, to the one or more ACARS end systems.

From the foregoing, it will be appreciated that, although specific embodiments have been described herein for purposes of illustration, various modifications may be made without deviating from the scope of the disclosure. Thus, the described embodiments are to be considered in all respects only as illustrative and not restrictive. In addition, all changes that come within the meaning and range of equivalency of the claims are to be embraced within their scope.

What is claimed is:

1. A method comprising:
transmitting one or more uplink messages from an ACARS over Internet Protocol (AoIP) ground datalink service provider to an AoIP gateway server, when an AoIP communication channel is available;
determining whether the one or more uplink messages have been received by the AoIP gateway server;
storing the one or more uplink messages in the AoIP gateway server when received;
notifying the AoIP ground datalink service provider when each uplink message is received by the AoIP gateway server;
determining whether there are any pending stored uplink messages to be sent from the AoIP gateway server to a communications management system onboard an aircraft;
sending the pending stored uplink messages, one at a time, from the AoIP gateway server to the communications management system;
transmitting a respective acknowledgement from the communications management system to the AoIP gateway server, when a corresponding uplink message has been received by the communications management system, wherein subsequent to each respective acknowledgement being received by the AoIP gateway server, the corresponding uplink message is discarded at the AoIP gateway server; and
sending each uplink message from the communications management system to one or more ACARS end systems onboard the aircraft;
wherein subsequent to each respective acknowledgement being received by the AoIP gateway server, a next one of the uplink messages is sent from the AoIP gateway server to the communications management system.

2. The method of claim 1, wherein if any of the uplink messages fail to be transferred to the communications management system within an acknowledgement time threshold, then the AoIP gateway server sends a failure indication to the AoIP ground datalink service provider.

3. The method of claim 1, wherein if any of the uplink messages fail to be transferred to the one or more ACARS end systems within an acknowledgement time threshold, then the communications management system sends a failure indication to the AoIP gateway server, which in turn transfers the failure indication to the AoIP ground datalink service provider.

4. The method of claim 1, wherein the AoIP gateway server includes an aircraft data gateway (ADG), or an integrated network server unit (INSU).

5. The method of claim 1, wherein the AoIP gateway server includes an AOIP gateway communication portion, and an AOIP gateway avionics portion.

6. The method of claim 1, wherein the communications management system comprises a communication management unit (CMU), or a communication management function (CMF).

7. The method of claim 1, wherein the one or more ACARS end systems comprise an aircraft condition monitoring system (ACMS), a digital flight data acquisition management unit (DFDAMU), a central maintenance computer (CMC), an electronic flight bag (EFB), a cabin terminal, a flight management system (FMS), a CMU/CMF application, or combinations thereof.

8. The method of claim 1, wherein the AoIP gateway server receives uplink messages, and converts the received uplink messages to ARINC 618 messages that are sent, one at a time, to the communications management system.

9. The method of claim 1, wherein the pending stored uplink messages are sent, one at a time, as ARINC 618 messages from the AoIP gateway server to the communications management system.

10. The method of claim 9, wherein each received ARINC 618 message is sent as a corresponding ARINC 619 message, from the communications management system to the one or more ACARS end systems.

11. A system comprising:
an ACARS over Internet Protocol (AoIP) ground datalink service provider operative to transmit one or more uplink messages;
an AoIP gateway server in operative communication with the AoIP ground datalink service provider, the AoIP gateway server operative to receive and store the one or more uplink messages transmitted by the AoIP ground datalink service provider;
wherein the AoIP gateway server is operative to send a transfer success message back to the AoIP ground datalink service provider for each uplink message received by the AoIP gateway server;
a communications management system onboard an aircraft and in operative communication with the AoIP gateway server; and
one or more ACARS end systems onboard the aircraft and in operative communication with the communications management system;
wherein the AoIP gateway server is operative to send the stored one or more uplink messages, one at a time, to the communications management system;
wherein when each uplink message is received by the communications management system from the AoIP gateway server, the communications management system sends a message acknowledgement to the AoIP gateway server;
wherein the communications management system is operative to send each received uplink message to the one or more ACARS end systems.

12. The system of claim 11, wherein if any of the uplink messages fail to be transferred to the communications management system within an acknowledgement time threshold, then the AoIP gateway server sends a failure indication to the AoIP ground datalink service provider.

13. The system of claim 11, wherein if any of the uplink messages fail to be transferred to the one or more ACARS end systems within an acknowledgement time threshold, then the communications management system sends a failure indication to the AoIP gateway server, which in turn transfers the failure indication to the AoIP ground datalink service provider.

14. The system of claim 11, wherein the AoIP gateway server includes an aircraft data gateway (ADG), or an integrated network server unit (INSU).

15. The system of claim 11, wherein the AoIP gateway server includes an AOIP gateway communication portion, and an AOIP gateway avionics portion.

16. The system of claim 11, wherein the communications management system comprises a communication management unit (CMU), or a communication management function (CMF).

17. The system of claim 11, wherein the one or more ACARS end systems comprise an aircraft condition monitoring system (ACMS), a digital flight data acquisition management unit (DFDAMU), a central maintenance computer (CMC), an electronic flight bag (EFB), a cabin terminal, a flight management system (FMS), a CMU/CMF application, or combinations thereof.

18. The system of claim 11, wherein the AoIP gateway server is operative to receive uplink messages, and convert the uplink messages to ARINC 618 messages that are sent, one at a time, to the communications management system.

19. The system of claim 11, wherein the AoIP gateway server is operative to send the stored one or more uplink messages, one at a time, as ARINC 618 messages to the communications management system.

20. The system of claim 19, wherein the communications management system is operative to send each received ARINC 618 message, as a corresponding ARINC 619 message, to the one or more ACARS end systems.
